(19) United States
(12) Patent Application Publication
(10) Pub. No.: US 2012/0272784 A1
(43) Pub. Date: Nov. 1, 2012

(54) Interchangeable Appliance Insert Components and System

(76) Inventors: Brent Bailey, Greenwood, MS (US); Curtis Joseph Vann, III, Greenwood, MS (US); Matthew Ortner, Greenwood, MS (US)

(21) Appl. No.: 13/435,882

(22) Filed: Mar. 30, 2012

Related U.S. Application Data
(60) Provisional application No. 61/516,230, filed on Mar. 31, 2011.
(60) Provisional application No. 61/479,603, filed on Apr. 27, 2011.

(51) Int. Cl. G05G 1/10; B23P 6/00; A47J 36/00

(52) U.S. Cl. 74/553; 16/110.1; 29/402.08

(57) ABSTRACT

A selectable and interchangeable accessory insert system for an appliance is disclosed. The appliance includes at least a handle or a knob. The handle includes at least a base portion and a first insert, with the first insert being separable from the base portion. The base portion being sized to receive a second insert after the first insert is separated therefrom. In an appliance with multiple knobs or handles, each knob or handle can include exchangeable inserts to allow the inserts to be exchanged to have similar appearances or features.

### CROSS REFERENCE TO RELATED APPLICATIONS

The present Patent Application is a formalization of previously filed, co-pending U.S. Provisional Patent Application Ser. No. 61/516,230, filed Mar. 31, 2011 and U.S. Provisional Patent Application Ser. No. 61/479,602, filed Apr. 27, 2011 by the inventors named in the present Application. This Patent Application claims the benefit of the filing date of these cited Provisional Patent Applications according to the statutes and rules governing provisional patent applications, particularly 35 U.S.C. §119(a)(i) and 37 C.F.R. §1.78(a)(4) and (a)(5). The specification and drawings of the Provisional Patent Applications referenced above are specifically incorporated herein by reference as if set forth in their entireties.

### FIELD OF THE INVENTION

The present invention generally relates to the use of decorative finishes or attachments for appliances, and in particular to a system for the selection and interchangeability of various insert components for appliances to enable customization of the visual appearance of such appliances to meet customer demands.

### BACKGROUND OF THE INVENTION

In the past, the color of most appliances in a typical home generally has been of a neutral color or appearance. For example, many appliances traditionally have been provided with a standard white or black appearance, and/or more recently, the use of brushed stainless steel appliances also has become more popular. It further has been known to special order appliances having different colors that more closely match the decor of a customer's kitchen. However, those customers also typically have been stuck with that color appliance until they decide to replace the entire appliance if they want to change the decor or color of the appliance to match the surrounding environment. Changing out one's appliances can, however, be expensive, especially for higher end or more commercial grade appliances. Increasingly, consumers are looking for more variety in the colors and decorative aspects of their appliances, but also need the flexibility to change the appearance of such appliances as the surrounding kitchen decor changes, without having to incur the significant expense of changing out their appliances.

Accordingly, it can be seen that a need exists for an interchangeable decoration system for appliances that addresses the foregoing and other related and unrelated problems in the art.

### BRIEF DESCRIPTION OF THE DRAWINGS

FIG. 1 is a perspective illustration of a first embodiment of the decorative interchangeable appliance insert components and system according to the present invention.

FIGS. 2A-2C are perspective illustrations of distinct inserts for an appliance knob, such as for a range according to the first knob embodiment, illustrating the use of various different material types, textures, colors, and designs for the knob and knob grip components.

FIGS. 3A-3D are perspective illustrations of a second embodiment of the interchangeable appliance accent inserts according to the principles of the present invention, illustrating the use of a different knob and handle configuration than shown in the first embodiment.

FIG. 4 is a perspective illustration of an embodiment of the interchangeable appliance accent inserts according to the principles of the present invention, illustrating the use of elastic or flexible sleeve materials that can be applied over existing handles and/or knob grips to provide different decorative appearances thereto.

FIG. 5 is a perspective illustration of an additional embodiment of an attachment mechanism for the interchangeable accent inserts for an appliance knob according to the principles of the present invention.

FIG. 6 is a perspective illustration of an additional embodiment of an attachment mechanism for the interchangeable accent inserts for an appliance knob according to the principles of the present invention.

FIG. 7 illustrates a first embodiment of an attachment and replacement mechanism for the interchangeable handle accent inserts according to the principles of the present invention.

FIG. 8 illustrates an additional embodiment of an attachment and replacement mechanism for the interchangeable handle accent inserts according to the principles of the present invention.

FIG. 9 illustrates a further embodiment of the interchangeable accent inserts of the present invention.

FIG. 10 illustrates a flowchart allowing customers to customize their appliance panels.

Those skilled in the art will appreciate and understand that, according to common practice, the various features of the drawings discussed below are not necessarily drawn to scale, and that the dimensions of various features and elements of the drawings may be expanded or reduced to more clearly illustrate the embodiments of the present invention described herein.

### DESCRIPTION OF THE INVENTION

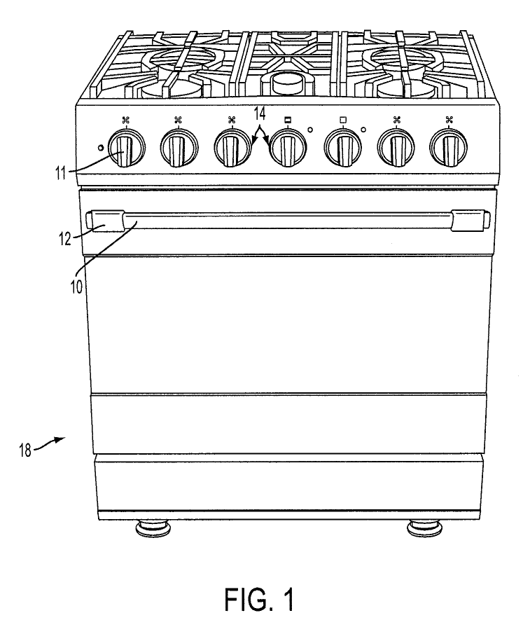

Referring now to the figures in which like numerals indicate like parts throughout the several views, FIGS. 1 through 10 generally illustrate various embodiments of interchangeable appliance accent inserts and systems for facilitating the interchangeability thereof according to the principles of the present invention. The present invention is designed to enable and provide customers with greater flexibility in designing and modifying the look or decor of their appliances to match or coordinate with the surrounding decor, including enabling after installations changes or modifications in such decorative attachments/inserts to correspond with similar changes in the surrounding decor. In the embodiments illustrated in the present figures, the appliance inserts of the present invention are shown as inserts for the handles, knobs, and knob grips of a range or oven. It will, however, be understood by those skilled in the art that the principles of the present invention can be applied to other appliances, for example, to handles or other features for refrigerators, knobs, buttons, etc., for a stand mixer, and/or for various other types of appliances and features thereof The attached figures thus are provided for illustration of preferred example embodiments and are not to be taken as limiting the present invention only for use with particular appliances and/or particular features thereof.

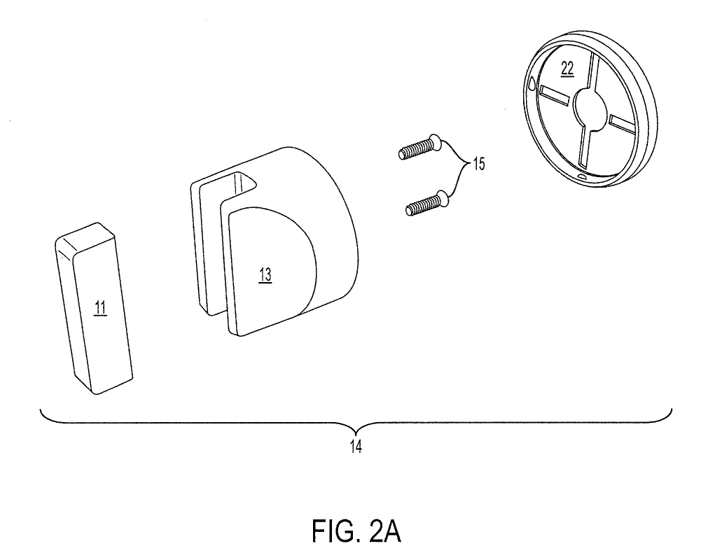

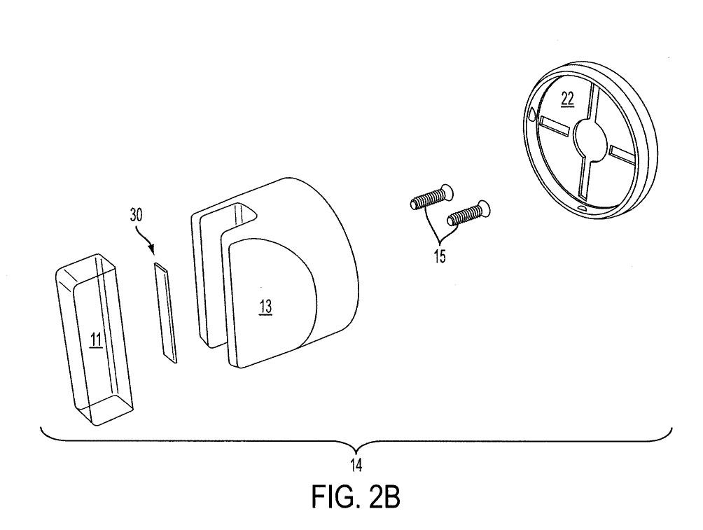

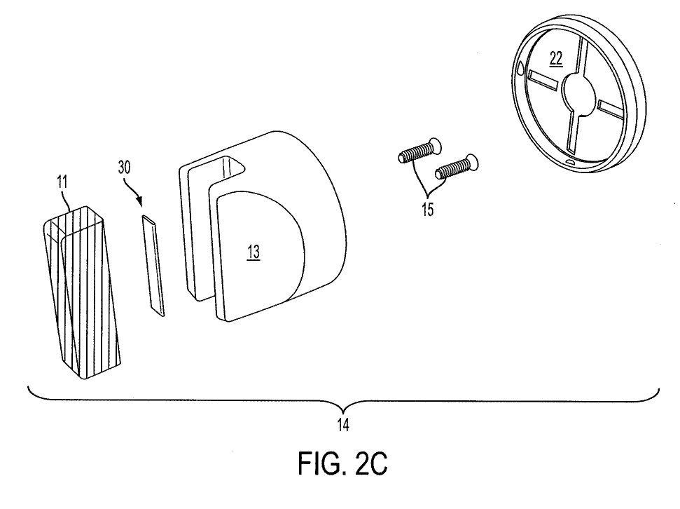

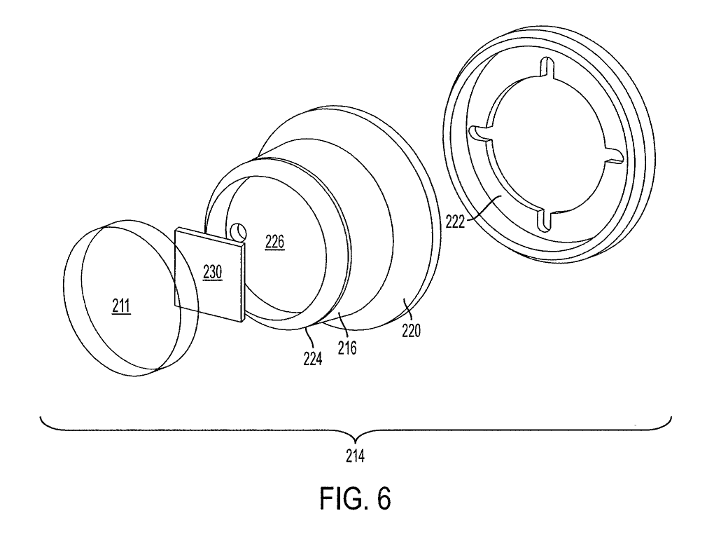

FIGS. 1 and 2A-2C generally illustrate a range or oven 18 incorporating the interchangeable inserts according to the present invention. In the first embodiment illustrated in FIG. 1, the appliance inserts of the present invention are shown as inserts 10/11 for the handle 12 and knobs 14 of a range or oven 18. FIGS. 2A-2C are perspective illustrations of various inserts for an appliance knob, such as for a range according to a first embodiment, illustrating the use of various different material types, textures, colors, and designs for the knob and knob grip components (FIG. 5). In FIGS. 2A-2C, insert 11 is received in a slot or channel of the base portion 13 of knob 14, which in turn is secured to a bezel 22 by an attachment means, such as a screw or screws 15, friction fitting, or other fastening systems. As shown in FIG. 2A, the insert 11 can be secured by fasteners such as screws 15 to the base portion 13 of knob 14. Alternatively, as shown in FIGS. 2B and 2C, the insert 11 can be secured to the base portion 13 of knob 14 by an adhesive 30. Also, the inserts 11 in FIGS. 1 and 2A through 2C can be selected to match the color, texture, design, or other appearance or feature of the base portion 13 (as shown in FIG. 2A), can be clear (as shown in FIG. 2B), or can be selected or otherwise modified to include/embody a color, texture, design, or other appearance or decorative feature as the customer desires, such as to match a neighboring cabinet (as shown in FIG. 2C).

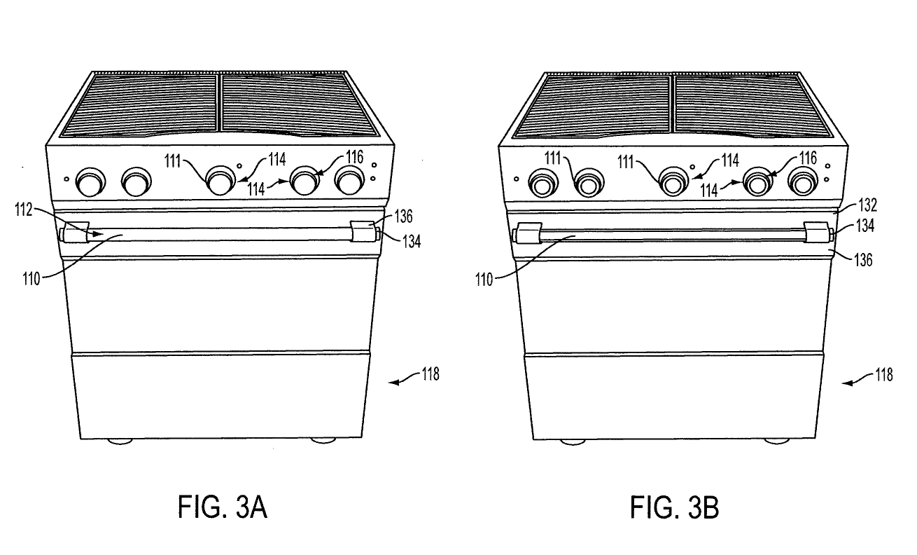

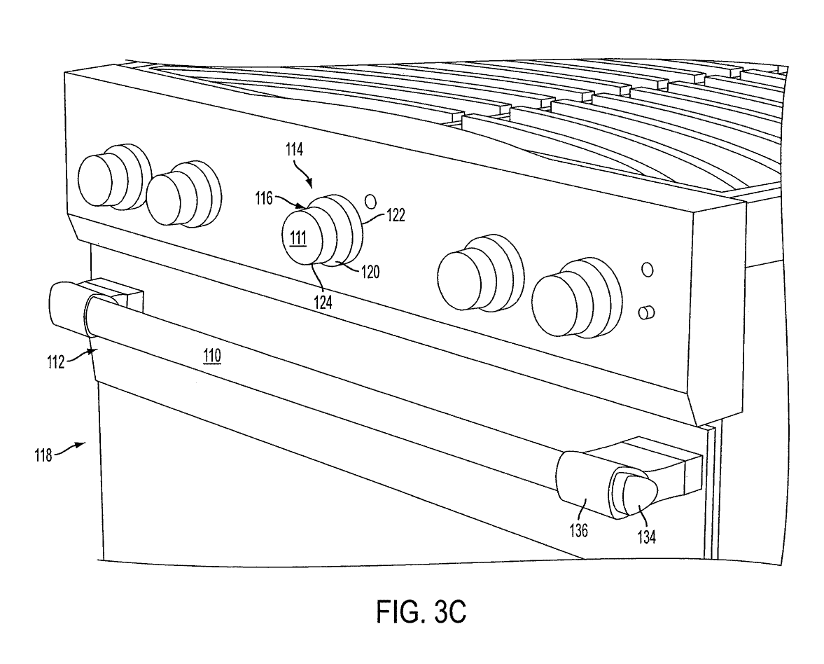

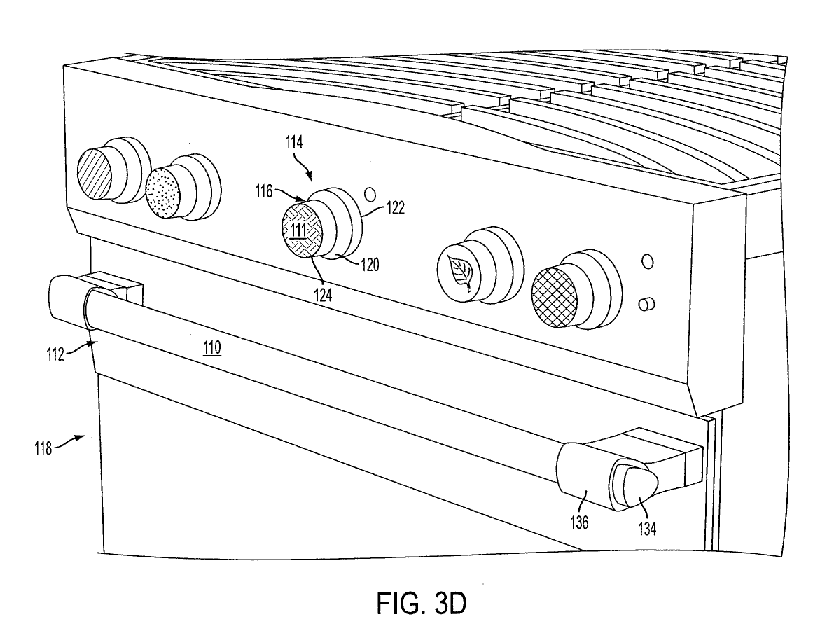

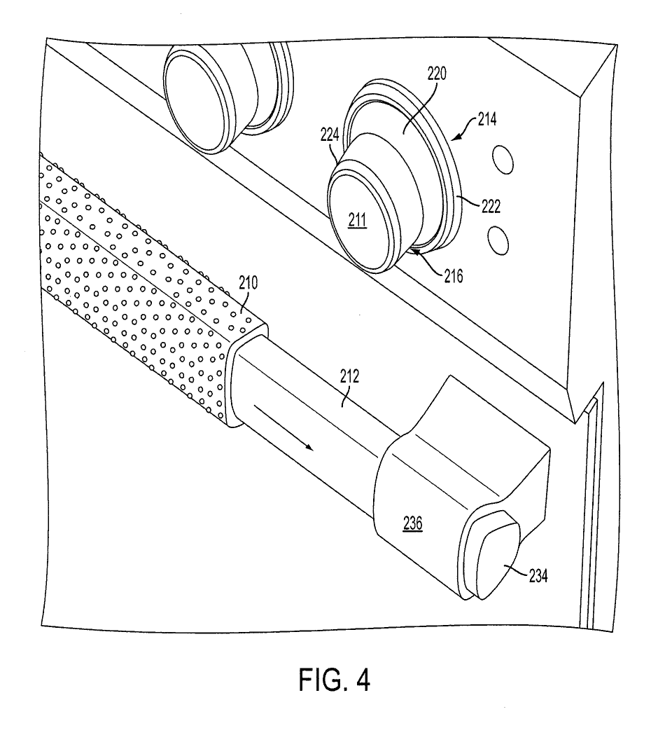

FIGS. 3A-3D are perspective illustrations of a second embodiment of the interchangeable appliance accent inserts according to the principles of the present invention, illustrating the use of a different knob and handle configuration than shown in the first embodiment. In FIG. 3A, a range 118 is shown with a colored oven door 150, but with its knobs 114, handle 112, cap 134, and handle bracket 136 being of a conventional brushed, stainless steel appearance. In FIG. 3B, the knob and handle inserts 110/111 have been replaced with decorative knob and handle inserts that substantially match the color and appearance or texture of the oven door. Similarly, FIG. 3C illustrates different appearances and materials (such as different color, texture and/or design featured knobs) for matching inserts for the handles the knobs of an appliance to provide different looks or appearances accenting the stainless steel appearance of the appliance. FIG. 3D is an exemplary figure that shows the interchangeability of the knob inserts with a number of designs, allowing the user to provide uniform appearance inserts, individually unique inserts, inserts that coordinate with an adjacent design (such as a themed pattern), or combinations of these and other designs.

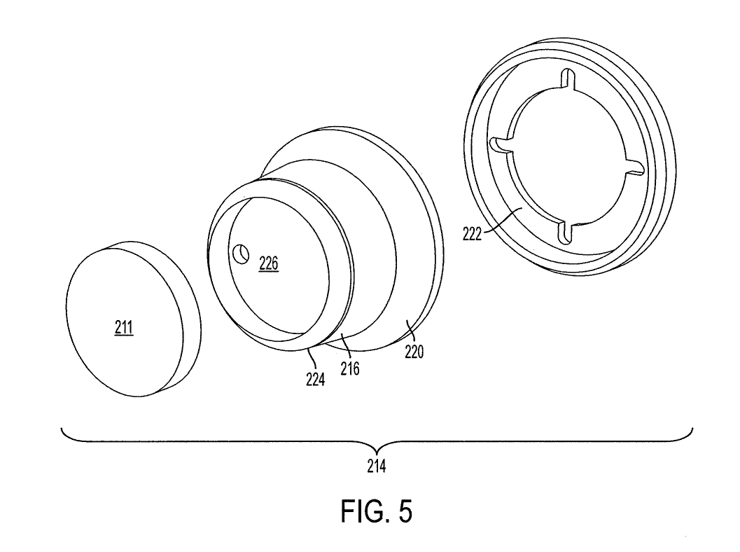

In still a further embodiment as illustrated in FIG. 4, a sleeve 219, formed from a flexible, elastic, rubberized or other synthetic or natural material such as a silicone sleeve material, with similar flexible or elastic materials also being useable, further can be applied to cover a desired portion or length of the handle 212, for the appliance inserts and knob grips 216. In this embodiment, the handle 212 is shown covered with a rubber or silicone sleeve material 219 or similar durable, stretch and tear resistant, food safe material that further generally is dishwasher/washing machine safe for easy cleaning. The sleeves can extend for the entire length or just a portion of the handle length and can be formed in multiple sections. The sleeves also can be formed with a variety of decorative features, including perforations that allow the underlying handle to be seen through the sleeve, and/or can be formed in different designs, including sayings, trademark designs, personalized images, and the like. Further, the rear portions of the sleeves 219 can be formed with textures, grips 221, including ridges, bumps, etc. Similarly, the grips 216 can be formed from elastic sleeve materials provided with varying textures and features.

In the embodiment illustrated in FIG. 5, a rubber knob grip 216 generally is fitted about the intermediate section 224 of the knob, which can be formed from a metal material, or can be plastic, injection molded knobs with simulated brushed stainless finish or other decorative finish as needed or desired. For example, an appliance insert, here shown as a light gauge stamped stainless steel insert having a brushed steel appearance to match the appearance of the knob and/or the appliance to which it is attached, can be placed or fitted into an insert receiving recess 226 defined in the front end of the knob. In this embodiment, the insert can be secured in the insert receiving recess of the knob by a snap or press fit or similar friction fitting. Thereafter, the knob will be placed over its bezel and can be secured to the front of the appliance by fasteners such as screws, bolts, or other removable fasteners.

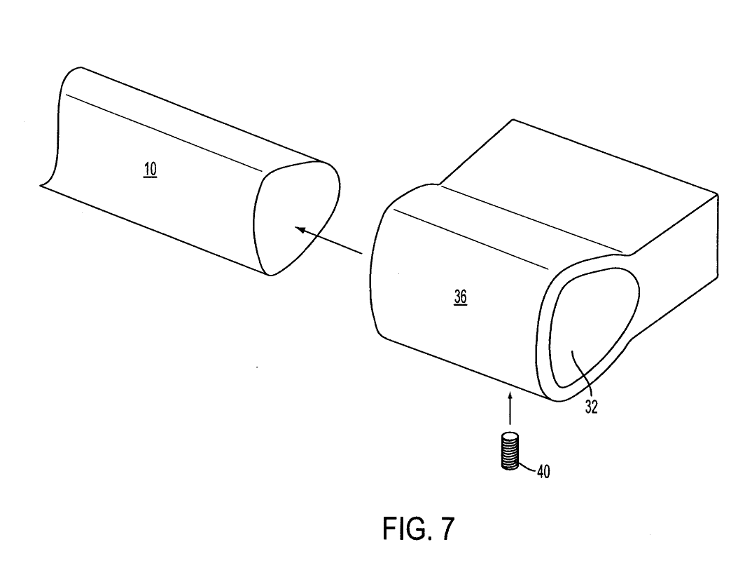

FIG. 6 is a perspective illustration of an additional embodiment of an attachment mechanism for the interchangeable accent inserts for an appliance knob according to the principles of the present invention. In FIG. 6, the knob insert 211 is fitted into the insert receiving recess 226 within the knob 214. In this embodiment, the appliance insert generally will be attached to its knob by screws inserted through the rear of the knob and received in fastener openings formed through the base of the insert receiving recess of the knob. The insert can be ceramic, plastic, or other synthetic material and can be releasably attached within the insert receiving recess 226 by a releasable adhesive material, here shown as a double-sided adhesive tape material 230, although it is further understood that other releasable adhesive materials such as a contact cement or other similar materials also can be used. The insert 211 can be a clear plastic, such as a Lexan® plastic insert, and remain clear if the customer desires, or alternatively can utilize the see-through capability of the insert to provide viewing of an internal decorative surface. For example, the user could attach a photograph or other decorative material to the rear side of the insert, or could paint or otherwise color the rear side of the accessory insert, and then attach the insert to the knob, such as with the double-sided adhesive tape or other releasable adhesive or other connecting means 230.

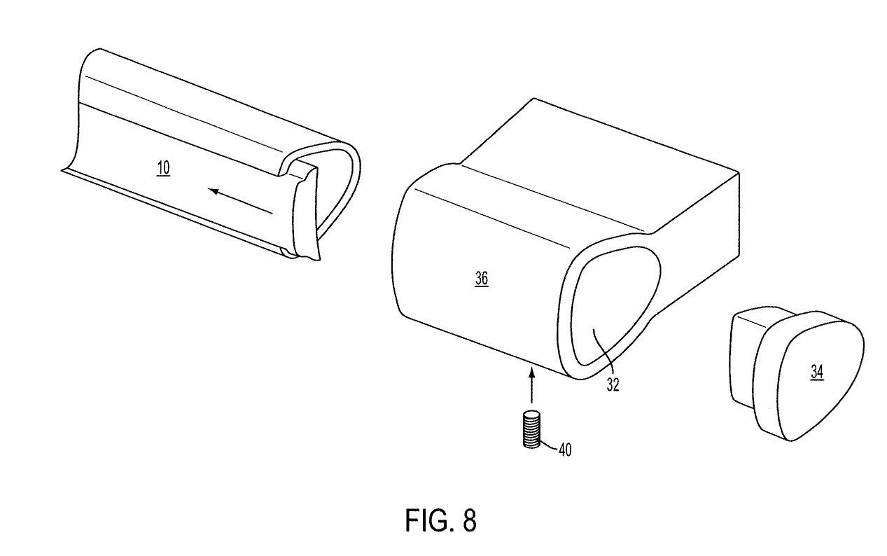

FIGS. 7-8 illustrate different embodiments of a replaceable handle insert 10, such as for an oven or range or for use on a refrigerator or other similar appliances. In FIG. 7, a conventional handle 12, which can be formed of stainless steel, aluminum extrusion, plastic, zinc die-casting, composite, or other synthetic or natural materials, having a polished or brushed steel aluminum or other material end cap 34, can be slid into a handle bracket 36 or receptacle, with the end of the handle being received within a handle passage 38 formed in the bracket. Once the handle is inserted to a desired length, a fastener 40, such as a set screw, can be applied to lock the handle in place. Similarly, other solid or substantially solid handle materials (such as a clear plastic, ceramic, etc.), also can be similarly mounted in the handle bracket(s).

Alternatively, as indicated in FIG. 8, instead of a handle 12 formed from a single or a substantially solid material, such as a metal material, a ceramic, plastic, or other substantially solid material, a handle sleeve 42 can be provided, having a recessed opening or track for receipt of a decorative appliance insert material 10, here illustrated as a wooden material insert. The insert 10 generally is configured to match the recess or track of the handle sleeve and can be slid therealong to place the insert within the handle sleeve. Thereafter, the handle, with the decorative insert therein, is insertable through the passage of the handle bracket and securable in place with a fastener such as a set screw 90. An end cap 34, here illustrated as having a substantially stainless steel appearance, then can be placed over and/or fitted within the open end 46 of the handle sleeve 42 to seal and close the end of the handle with the insert secured therein. The end cap further can be formed from a variety of different materials and/or can be provided with a variety of different colors, textures, and appearances as further desired. Additionally, the insert 10 also could be painted a desired color prior to insertion into the handle. Thus, the user can order a generic handle insert, which can be of a wood grain texture or material, or other types of material, and can either have it painted or paint it themselves as desired to match a desired look or decor, to simply change the appearance of their existing handle accessory insert.

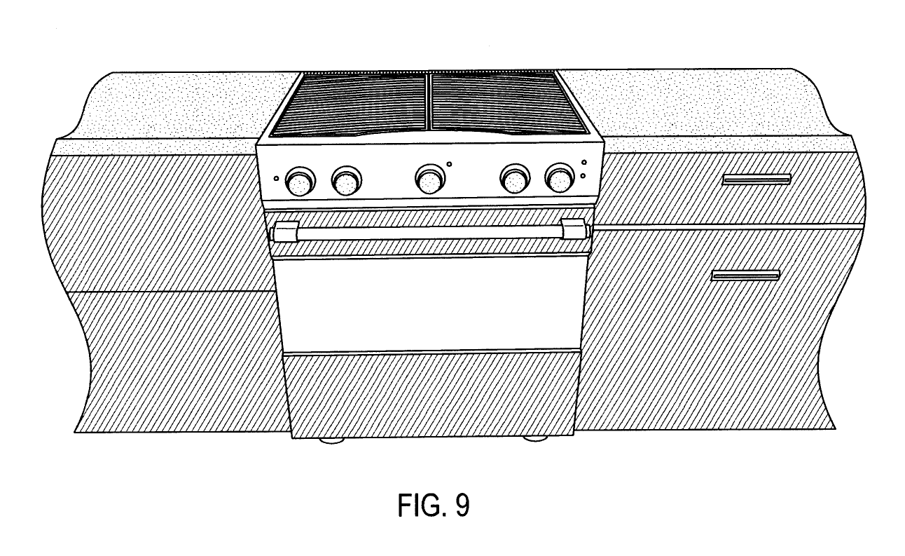

FIG. 9 illustrates a further embodiment of the present invention, in which different materials and textures, including metals, leather, or synthetic fabric materials, including having an animal print appearance can be used. Also as shown in FIG. 9, the inserts for the control knobs and/or the oven handles can be formed as matching colors and/or materials that can match the colors of the oven door panels and/or surrounding cabinets or counter tops.

As a result of the present invention, customers are provided with a substantially expansive choice of different decor options by which they can customize the look and feel of their appliances. For example, a customer could choose to have the facing surfaces of their appliances in a desired color, such as white, red, etc., that matches the walls of their kitchen or the color of their countertops. The customer can then select or change-out the decorative inserts for the control knobs and handles of their appliances to utilize decorative inserts or trim that could, for example, include the material that is substantially the same as or matches the surrounding countertops, is of a slightly different color so as to match the trim of their walls, and/or can be of any varying design they so desire. Consumers can also submit photographs, personal drawings or images, and/or further can select from a variety of published/selected artistic or patterned designs to further customize the appliance inserts. The present invention also enables the change-out or replacement of such appliance inserts as needed, including replacement by the customer if so desired. Thus, if the customer changes the decor of the surrounding area in which the appliance is used, they are not stuck with the old designs or colors, but rather can remove and change out the appliance inserts as needed. Customers accordingly are able to select and purchase inserts for knobs, handles, knob sleeves or other features of their appliances and purchase replacement or other interchangeable inserts as needed.

As illustrated in the figures, the interchangeable appliance inserts according to the present invention can include a variety of different materials, including brushed or polished stainless steel or other, similar metal materials, wood, stone and/or other natural materials, and/or rubber, plastics or other synthetic materials. Alternatively, the inserts also could be formed from various ceramic or solid surface materials such as Corian®, Silestone®, Cambria® , CaesarStone®, or other similar materials that substantially match the look, feel and composition of surrounding countertops. Additionally, any of these materials further can be colored and textured so as to match the surrounding decor or the color and/or appearance of the appliance itself, such as the handle and knob inserts being colored with substantially the same red color as the door of the oven to which they are applied. Such a coating can be formed, for example, using powder metal coating techniques, or can be applied using high gloss or flat enamel paint, rubberized coatings, or other similar coating materials, or additionally could be wrapped with a removable, stick-on covering such as a vinyl, rubber or other synthetic or textile covering.

Still further, as illustrated in the figures, in addition to different colors, the appliance inserts also can be provided with a variety of different designs, i.e., swirls, initials or monograms, photos, crests, or other or designs, including designs having a hand painted appearance, as well as be provided with a variety of different textures or finishes. For example, wood grain textures or other similar naturally appearing finishes or textured accents, or resinous inserts having various designs and/or materials, such as leaves, washers, reeds, etc., embedded in a clear or colored/tinted plastic or resinous material, can be provided. In addition, the handle and knob inserts can be provided with a tacky feel, with raised designs, ribs, bumps or protrusions, a leather appearance, “diamond-plate” appearance, or a variety of other decorative appearances.

Further still, the inserts can be custom designed. In such an embodiment, a customer could be provided with or could purchase a supply of dried clay or ceramic disks of a size and configuration to fit the control knobs of their particular appliance. Customers so desiring could design their own decorative appearances, apply them to the insert disks and have the disks glazed and fired at a local pottery shop. Alternatively, the customers could simply go online and order a particular color or design disks and/or handle inserts, and as a further alternative could upload their own decorative designs, pictures, etc. that could then be applied to the knob and handle inserts by the manufacturer or a third-party contractor, and then will be shipped to customers for installation.

Even further still, the decorative inserts can be combined with shells for the appliance cabinet and/or replaceable decorative panels, such as etched glass inserts for the front of an oven door. For example, rather than utilizing conventional stainless steel fronts for the range or other appliance, different color fronts or panels can be used. Alternatively, shells can be fitted over the various door panel sections and/or the control panel to provide different color and/or textured effects, such as for matching the color of the range to the surrounding cabinetry. In such an embodiment, such shells can be formed from a metal or other, similar durable material that can be adapted to simply slide over and press fit or be otherwise attached onto the existing control panel and/or door panels, or can be provided as replacement parts for the existing panels.

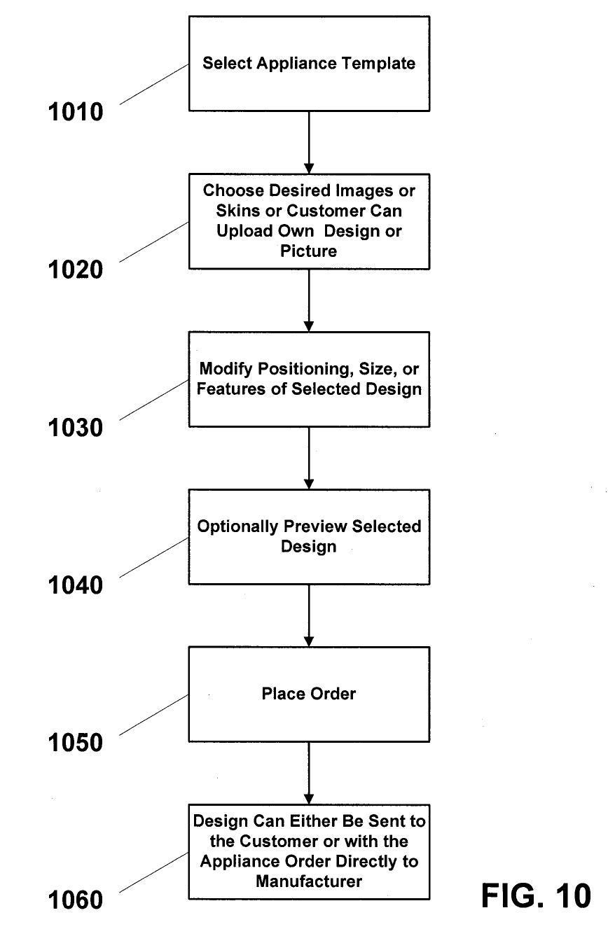

In addition, the shells can be formed as skins or appliqués having a desired decorative appearance and which can be applied to the panels and/or glass of the door. For example, consumers can go onto a website and order “skins” or appliqués for their appliances. An exemplary process of such design is illustrated in the flowchart shown in FIG. 10 and is detailed hereinbelow. As a first step at 1010, the customers will select a particular template, i.e., a control panel, door panels, etc., for a range or other panels for other types of appliances. Thereafter, at step 1020, the customer has the options of choosing existing images or skins from the website's image catalog. For example, various sports teams' logos or names and colors can be used as well as a variety of other, different designs. As an alternative option, the customer can upload an image or picture of their own to create their own unique design.

Once the design has been selected, at step 1030, the customer will then position or apply the image to the template. As a part of this positioning process, the customer can select various parameters such as width, height, rotation, transparency, location, etc., for the image and apply it to the template areas. The customer can further add text, shapes, or other images to further create a unique or decidedly personal covering. Thereafter, at step 1040, the customer has the option to preview their selected appliqué images as assembled on a range or other appliance. If the selected design meets with their approval, at step 1050, the customer can proceed to order and ship the appliqué design, or alternatively, can further customize or change the image until it meets their criteria. Thereafter, at step 1060, the skins or appliqués will be sent to the customer for application to their ranges, grills, or other appliances, or, alternatively, the design can be included with an appliance order directly to the manufacturer with the design installed directly on the ordered appliance by the manufacturer.

As a further alternative, a new glass insert or an appliqué for a glass insert also can be provided having a desired design. The glass insert can be etched with the desired design to provide a more robust and distinctive or higher quality appearance. Alternatively, a skin can simply be applied over the glass area and/or colored shell areas of the range.

Various features and advantages of the present invention will become apparent to those of ordinary skill in the art upon a review of the foregoing description when taken in conjunction with the accompanying figures. In addition, it will be understood by those skilled in the art that while the present invention has been described above with reference to certain embodiments, various modifications, changes and additions can be made thereto without departing from the spirit and scope of the present invention.

1. A selectable and interchangeable accessory insert system for an appliance comprising:
a handle including at least a base portion and an insert;
the first insert being separable from the base portion;
the base portion being sized to receive a replacement insert.

2. The system of claim 1 wherein the appliance is a range or an oven.

3. The system of claim 1 wherein the insert and the replacement insert are sized to be received into a slot or channel in the handle.

4. The system of claim 1 wherein at least one of the insert or the replacement insert is sized to be received over the base portion.

5. The system of claim 1 wherein the replacement insert comprises a first color; and wherein the appliance includes a second handle; wherein the second handle is sized to receive a second handle insert; and wherein the second handle insert is identical in color to the first color of the replacement insert.

6. The system of claim 1 wherein the replacement insert has a first texture; and wherein the appliance includes a second handle; wherein the second handle is sized to receive a second handle insert; and wherein the second handle insert is identical in texture to the first texture of the replacement insert.

7. The system of claim 1 wherein the replacement insert is a first design; and wherein the appliance includes a second handle; wherein the second handle is sized to receive a second handle insert; and wherein the second handle insert is identical in design to the first design of the replacement insert.

8. The system of claim 1 wherein the replacement insert is removable from the handle by removal of a set screw.

9. The system of claim 1 wherein the replacement insert is an insert that includes a skin or appliqué; and wherein the appliance includes a second handle; wherein the second handle is sized to receive a second handle insert; and wherein the second handle insert is identical in skin or appliqué to the first skin or appliqué of the replacement insert.

10. A method of replacing an insert with a replacement insert for a handle or knob of an appliance, the method comprising:
separating the insert from a base portion of the handle or knob; and,
inserting the replacement insert in the base portion.

11. The method of claim 1 wherein the appliance is a range or an oven.

12. The method of claim 1 wherein the insert and the replacement insert are sized to be received into a slot or channel in the handle.

13. The method of claim 1 wherein the insert is sized to be received over the base portion.

14. The method of claim 1 wherein the replacement insert is a first color; and wherein the appliance includes a second handle; wherein the second handle is sized to receive a second handle insert; and wherein the second handle insert is identical in color to the first color of the replacement insert.

15. The method of claim 1 wherein the replacement insert has a first texture; and wherein the appliance includes a second handle; wherein the second handle is sized to receive a second handle insert; and wherein the second handle insert is identical in texture to the first texture of the replacement insert.

16. The method of claim 1 wherein the replacement insert is a first design; and wherein the appliance includes a second handle; wherein the second handle is sized to receive a second handle insert; and wherein the second handle insert is identical in design to the first design of the replacement insert.

17. The method of claim 1 wherein the replacement insert is removable from the handle by a set screw or can be removable along screw threads.

18. The method of claim 1 wherein the replacement insert is an insert that includes a skin or appliqué; and wherein the appliance includes a second handle; wherein the second handle is sized to receive a second handle insert; and wherein the second handle insert is identical in skin or appliqué to the first skin or appliqué of the replacement insert.

19. An appliance comprising:
a first element controlled by a first knob and a second element controlled by a second knob;
the first knob including a first knob base portion and a first knob insert;
the second knob including a second knob base portion and a second knob insert;
the first knob insert and the second knob insert being formed of a first material;
wherein the first knob insert is exchangeable with a first knob replacement insert;
wherein the second knob insert is exchangeable with a second knob replacement insert;
wherein the first knob replacement insert and the second knob replacement insert are formed from a second material.

20. The appliance of claim 19 wherein the first material and the second material are identical to either (1) a color of the appliance, an adjacent cabinet, or another knob of the appliance; (2) a texture of the appliance, an adjacent cabinet, or another knob of the appliance; or (3) a design of the appliance, an adjacent cabinet, or another knob of the appliance.
